(19) United States
(12) Patent Application Publication
(10) Pub. No.: US 2006/0007669 A1
(43) Pub. Date: Jan. 12, 2006

(54) Ergonomic hand-mounted illumination device

(76) Inventor: Paul C. Blackburn, San Diego, CA (US)

Correspondence Address: Paul C. Blackburn, PO Box 6584, San Diego, CA, 92166-0584, US

(21) Appl. No.: 10/887,988

(22) Filed: Jul. 9, 2004

(51) Int. Cl. F21V 21/08

(52) U.S. Cl. 362/103

(57) ABSTRACT

A hand-mounted illumination device wherein the point of light emission of an illumination device (12) is disposed between two adjacent fingers, such that the point of light emission is protected by the fingers and illuminates areas between the adjacent fingers, under the fingers and hand, around the fingertips, and distally of the hand. The point of light emission is attached to the side of a finger by means of a partial-fingered glove (10) or a strap (23). Illumination device (12) components, comprising an electrical energy storage device (16), a switch (17), a light-emitting device (15), an electric cable (18), a finger housing (14), a light transmission device (26), and a hand housing (27), may be disposed between the two adjacent fingers, elsewhere on the hand, or in locations not on the hand, provided that the point of light emission of illumination device (12) is disposed between the two adjacent fingers. The illumination device (12) may be operated using the hand to which it is attached.

### CROSS REFERENCE TO RELATED APPLICATIONS

Not Applicable.

### FEDERALLY SPONSORED RESEARCH

Not Applicable.

### SEQUENCE LISTING OR PROGRAM

Not Applicable.

### FIELD OF THE INVENTION

The invention relates to hand-mounted illumination devices.

### BACKGROUND OF THE INVENTION

Hand-mounted illumination devices offer a combination of advantages that overcome limitations inherent in hand-held, head-mounted, and arm-mounted illumination devices, including but not limited to the following. Hand-held illumination devices monopolize the hand that holds them, must be located and retrieved from storage prior to use, and are subject to loss before, during, and after use. Once activated, head-mounted illumination devices free both hands for use but light a much larger area than necessary, add bulk to the head, apply uncomfortable pressure to the head, are difficult to attach securely to the head absent a chin strap, require moving a hand away from the work area for operation, increase the risk of the head being snagged by a foreign object, follow the motion of the head thereby lighting areas being viewed whether desired or not, are not aesthetically appealing, and increase the prominence of the head. Arm-mounted lights require movement of the entire arm to direct light, illuminate the area around the hand poorly, are difficult to maintain in position on the arm, and are awkward in appearance.

Unlike hand-held devices, hand-mounted devices free both hands for use and are securely fastened to the user so that when worn they are instantly available for use and not subject to loss. Unlike head-mounted devices, hand-mounted devices may be rapidly operated by the hand to which they are attached, illuminate objects being manipulated by the hand rather than following a user's head motions, do not require bulky head straps, are more securely attached to the user, do not discomfort the head, and due to their proximity to objects being manipulated by the hand require lower illumination power, which is particularly important where excessive lighting can be annoying or even dangerous, as when night vision must be maintained or when stray light may betray position in combat. Unlike arm-mounted devices, hand-mounted devices are easier to aim, require less power, and provide superior lighting under and around the fingertips.

Hand-mounted devices are closer to objects being manipulated by the hand than illumination devices mounted elsewhere and therefore provide equivalent useful illumination of these objects at lower power, which means that hand-mounted devices can be smaller, lighter, and more robust. The advantages of hand-mounted devices make them particularly useful in dynamic nighttime environments that require athletic hand motions in coordination with low-power illumination, such as during sailing or in combat, where encumbered hands, lost flashlights, or excessive or prominent lighting can have life or death repercussions. However, hand-mounted devices are also useful in less demanding circumstances, such as when lighting a keyhole in cold weather.

Inventors have patented hand-mounted illumination devices since 1891, U.S. Pat. No. 455,972 to Oudin et al. (1891), using gloves, straps, bands, pockets, or rings to attach illumination components to the hand. The prior art describes a variety of configurations distinguishable from each other by the location on the hand of the point or points of light emission of the illumination device. The prior art places the point of light emission either on the back of the hand, the back or top of the finger, the fingertip, between the thumb and first finger, on the palm, or a combination of one or more of these locations. As described below, all of these configurations result in one or more of the following drawbacks: poor illumination, limitations on finger and hand dexterity, user discomfort, increased risk of snagging the hand, risk of damage to illumination components, or compromised aesthetics.

Placing the point of light emission on the back of a finger creates shadows under the finger and hand. The closer the point of light emission is to the base of a finger, the worse this shadowing becomes. These shadows significantly reduce the ability of these devices to illuminate objects under the hand, such as maps or instrument controls. A back-of-the-finger, position may also limit the ability of the finger to bend if a mounting device, wire or fiber optic cable traverses over the top of one or more finger joints, because such components do not stretch and bend as easy as the skin on the back of a finger. A back-of-the-finger position also exposes the device to damage, may decrease user safety due to an increased risk that the illumination device and its mounting may be caught on foreign objects, and places the illumination device in full view, thereby compromising hand aesthetics. A number of patents describe such placement. U.S. Pat. No. 918,181 to Meadows (1909); U.S. Pat. No. 1,199,710 to Newton (1916); U.S. Pat. No. 1,215,389 to Lauray (1917); U.S. Pat. No. 1,553,860 to Hopper (1925); U.S. Pat. No. 1,754,570 to Pickett (1930); U.S. Pat. No. 3,638,011 to Bain et al. (1972); U.S. Pat. No. 5,124,892 to Lambert (1992); U.S. Pat. No. 5,283,722 to Koenen at al. (1994) and related U.S. Pat. No. 5,816,676 to Koenen Myers et al. (1998); U.S. Pat. App. Pub. No. 2004/0032750.

Placing the point of light emission on the back of a hand exacerbates the aforementioned shadowing problem. Such inventions illuminate the back of the fingers and knuckles but cast shadows under the fingers and hand, particularly when the fingers are flexed. As such, they are capable only of making the hand more visible and illuminating distant objects. Also, back-of-the-hand locations increase the risk of snags and damage to the illumination device, are difficult to integrate into glove aesthetics, and if straps are used, require a bulky and awkward strapping system. U.S. Pat. No. 674,770 to Hull (1901); U.S. Pat. No. 1,015,715 to Schindler (1912); U.S. Pat. No. 1,046,225 to Schindler (1912); U.S. Pat. No. 1,165,970 to Harris (1915); U.S. Pat. No. 1,173,269 to Heidemann (1916); U.S. Pat. No. 1,197,652 to Newton (1916); U.S. Pat. No. 1,230,943 to Sundh (1917); U.S. Pat. No. 1,402,609 to Hodous (1922); U.S. Pat. No. 1,416,653 to Lenneberg (1922); U.S. Pat. No. 1,496,484 to Monaco (1924); U.S. Pat. No. 1,504,980 to Schultz (1924); U.S. Pat. No. 1,531,373 to Bigelow (1925); U.S. Pat. No. 1,709,850 to Hodecker (1929); U.S. Pat. No. 1,906,193 to Vitale (1933); U.S. Pat. No. 3,112,889 to Marmo et al. (1963); U.S. Pat. No. 4,425,600 to Barnhart (1984); U.S. Pat. No. 4,521,832 to Barbour (1985); U.S. Pat. No. 5,255,167 to Toussaint et al. (1993); U.S. Pat. No. 5,345,368 to Huff (1994); U.S. Pat. No. 5,424,922 to Wise (1995); U.S. Pat. No. 6,006,357 to Mead (1999).

Positioning the point of light emission on a fingertip eliminates shadows on or near the work surface. However, this placement significantly limits the use of both the finger to which the device is attached and the hand as a whole, making such devices unsuitable for activities that require bare or unencumbered fingertips or that subject the device to risk of damage. As such, most fingertip-mounted devices are designed for use in controlled environments that do not require athletic hand motions, such as during surgery or casual reading. Those devices that are integrated into sports gloves severely limit the user's finger dexterity. Integrating a light into a glove fingertip also requires relatively complex fabrication techniques to limit fingertip bulk. A number of patents describe such placement. U.S. Pat. No. 455,972 to Oudin et al. (1891); U.S. Pat. No. 914,975 to Radley (1909); U.S. Pat. No. 1,245,817 to Suserud (1917); U.S. Pat. No. 4,422,131 to Clanton et al. (1983); U.S. Pat. No. 5,086,378 to Prince (1992); U.S. Pat. No. 5,535,105 to Koenen Myers et al. (1996); U.S. Pat. No. 6,592,235 to Mayo (2003); U.S. Pat. No. 6,709,142 to Gyori (2004).

Positioning the point of light emission between the thumb and first finger cannot illuminate under the hand or in front of the fingers, see U.S. Pat. No. 4,625,339 to Peters (1986), unless the device projects into the gripping area between the thumb and first finger and is bent inward, as described in the “dogleg” device in U.S. Pat. No. 5,448,458 to Smyly, Jr. (1995). Such placement obstructs the area of the hand used for grasping, compromises use of the hand, and exposes the illumination device to damage. Devices of this type are also unaesthetic and awkward.

In an effort to improve lighting under the hand, recent patents have described devices that wrap around the hand and may be positioned either on the palm or the back of the hand. Positioning the point of light emission on the palm effectively illuminates the area under the hand, but subjects the illumination components to risk of damage and limits use of the hand including the ability of the hand to grasp objects. U.S. Pat. No. 5,469,342 to Chien (1995); U.S. Pat. No. 6,715,897 to Rowe et al. (2004).

Recent prior art contained in U.S. Pat. No. 6,711,746 to Orellana (2004) describes a glove with pockets throughout the skin of the glove containing chemo-luminescent compounds, except for areas around the finger joints. This is the only know prior art that places a point of illumination on the side of a finger between two fingers. This device differs from the invention described here in a variety of ways, including that the point of illumination is not limited to the side of one or more fingers between adjacent fingers. As such, a great portion of the illumination components of this device would be subject to damage during athletic hand motions. Further, the device is not able to project a focused beam of light toward distant objects, would require complex fabrication techniques, and significantly increase the bulk of the hand.

Due to the drawbacks inherent in the foregoing prior art, all of this prior art either illuminates poorly, limits dexterity, subjects the illumination components to a substantial risk of damage, subjects users to increased safety risks and discomfort, or compromises the aesthetics of the hand, finger, or glove. As a consequence, these types of hand-mounted illumination devices are not in common use.

### SUMMARY OF THE INVENTION

My hand-mounted illumination device differs fundamentally from all prior art in a simple yet critical way: it places the illumination device's point of light emission between two adjacent fingers such that the point of light emission is in whole or in part between the fingers when the fingers are extended alongside each other. As described below, this placement overcomes the inherent limitations of the prior art without adversely impacting hand comfort. In particular, a between-the-finger location for the point of light emission offers a number of advantages, including but not limited to the following.

First, the adjacent fingers protect and cover the point of light emission as well as any illumination components located between the fingers, thereby reducing the risk of damage to the illumination device and the risk of personal injury caused by snagging of the device. This shielding action is particularly effective when the hand is made into a fist or when grasping, which are also the circumstances during which hand lights are most subject to potentially damaging forces.

Second, a small illumination device may be incorporated into the side of a glove finger such that it has little to no impact on hand dexterity. In the past, illumination devices were too large to fit comfortably between the fingers and provide useable light. Now, light-emitting diodes, “button” batteries, and fiber optic cables permit the fabrication of illumination devices slim enough to fit between the fingers without limiting finger motion or comfort. A between-the-fingers location does not encumber the fingertips and when located between the finger joints has no impact on finger articulation.

Third, a small illumination device may be incorporated into the side of a glove finger such that it has little to no impact on the glove's shape, function, or appearance. A between-the-fingers location conceals the point light emission from view when the fingers are pressed together, thereby minimizing the visual and aesthetic impact of the illumination components. When all of the illumination components except the point of light emission are mounted within the outer skin of a glove, the illumination components become almost invisible to others, making the device suitable for non-technical gloves, fashion gloves, or covert operations.

Fourth, a between-the-fingers position provides superior illumination. When located between the fingers an illumination device can light areas under the hand and fingers and around the fingertips, even when the fingers are flexed. Although the device creates lateral shadows on the opposite sides of the fingers from the point of light emission, these shadows may be minimized by finger and hand placement or by mounting additional illumination devices between other fingers. Such shadows are an advantage in that they limit stray light and glare, which can be annoying or even dangerous to those who must preserve their night vision or avoid being seen. This improved near-hand illumination does not limit the device's ability to illuminate distant objects because when the fingers are spread apart the hand does not block the projection of a beam of light.

Fifth, a between-the-fingers location permits rapid one-handed operation, thereby further increasing functionality, limiting stray light, and extending battery life.

Sixth, the present invention is based on well known, readily available, compact “pinch” or “keychain” light technology that can be mounted on a glove with minimal, inexpensive modification of existing light and glove designs and manufacturing techniques. The preferred alternative requires only the fabrication of a small pocket in the side of a finger of a glove and the insertion of a small “pinch” light into this pocket.

The present invention's lightweight ergonomic design and simple robust construction may be integrated into a wide variety of gloves, including but not limited to those designed for bicycling, sailing, skiing, construction, combat, flight, climbing, kayaking, driving, cold-weather protection, and firefighting, without compromising either utility or aesthetics.

As described below, a variety of mountings, including gloves, straps, or other fasteners, can maintain the point of light emission between the fingers. In addition, the illumination device components may be configured in a variety of ways. Possible alternative configurations include: location of the entire illumination device between the fingers; location of the illumination device's power source and/or switch elsewhere on the hand or in a remote location off the hand; or use of one or more fiber optic cables to transmit one or more beams of light from a remote light source to one or more points of light emission located on the side of one or more fingers. Further, a illumination device may comprise one or more light emitting devices with the same or different colors, intensities, and foci of light, allowing, for example, a single illumination device or multiple illumination devices to combine infrared, low power, high power, or laser lighting functions on one or more fingers of the same hand. The small size of the illumination components also means that the illumination device may be fully encapsulated or otherwise made water and dustproof.

Accordingly, several objects and advantages of my hand-mounted illumination device are:
(a) to provide a hand-mounted illumination device that illuminates work surfaces and objects between the fingers, under the hand, and around the fingertips as well as distant objects, yet limits stray illumination;
(b) to provide a hand-mounted illumination device that may be operated by the hand to which it is mounted, the other hand, or another protrusion such as a chin or foreign object;
(c) to provide a durable hand-mounted illumination device that permits full use of the hand to which the illumination device is attached so that it may be used in demanding environments, such as those found in sporting activities, combat, or manual labor;
(d) to provide a hand-mounted illumination device in which the illumination device is securely attached to the hand covering such that it is easily found and activated, thereby reducing the risk of either permanent or temporary loss during use;
(e) to provide a hand-mounted illumination device that increases personal safety by limiting the risk of the illumination device snagging foreign objects;
(f) to provide a hand-mounted illumination device that is durable and protected by the hand itself so as to reduce the risk of damage to the illumination device during use of the hand;
(g) to provide a hand-mounted illumination device that can be integrated into a glove such that the illumination device is comfortable to wear, unobvious, and aesthetically pleasing;
(h) to provide a hand-mounted illumination device that incorporates readily available, robust, inexpensive illumination technology into gloves with minimal alteration of existing light or glove design or fabrication techniques, such that the hand-mounted illumination device is compatible with gloves adapted for a wide variety of uses;
(i) to provide an illumination device that may be inserted into tight spaces along with a hand, for example during mechanical work; and
(j) to provide an illumination device that may be removed from its glove or other attachment device for glove laundering, battery replacement, illumination device servicing, and/or the substitution of illumination sources that emit light with differing intensities, foci, and/or wavelengths, including but not limited to infrared and ultraviolet illumination.

Additional objects and advantages of my hand-mounted illumination device will become apparent from the following detailed description considered in conjunction with the accompanying drawing figures.

### BRIEF DESCRIPTION OF THE DRAWINGS

In the drawing figures, closely related figures have the same number but different alphabetic suffixes.

FIG. 1 is a side view of the thumb and fingers portion of a hand covered by a partial-fingered glove to which is attached on the side of the glove's second finger an illumination device; this view also demonstrates how the illumination device may be accessed and activated by the thumb of the same hand.

FIGS. 2A and 2B are side and top views, respectively, of the illumination device of FIGS. 1, 3, 4, 5, 6, 7, and 8.

FIG. 3 is a perspective view of a hand and partial-fingered glove with an illumination device attached to the side of the glove's second finger.

FIG. 4 is a side view of a hand and partial-fingered glove with an illumination device attached to the side of the glove's second finger, which demonstrates how the illumination device is enclosed between the fingers during gripping.

FIG. 5 is a top view of a hand and partial-fingered glove with an illumination device attached to the side of the glove's second finger.

FIG. 6 is a top view of a full-fingered glove with two illumination devices attached to the sides of the glove's second and third fingers.

FIG. 7 is a top view of an illumination device attached to the second and third fingers of a hand by a strap so that the illumination device is held between the second and third fingers.

FIG. 8 is a perspective view of a hand and partial-fingered glove with the battery, switch and light emitting device contained in a pocket in the back of the glove, wherein the light emitting device is attached to a fiber optic cable that runs through a channel in the glove to an exit point on the side of the glove's second finger.

FIG. 9 is a side view of a hand and partial-fingered glove with a housing in a pocket on the back of the glove containing a battery and switch attached to electrically conductive wires that pass through a channel that runs to the distal end of the glove's second finger in which is disposed a light-emitting device.

The reference numerals used in the drawing include the following:
10 partial-fingered glove
11 finger pocket
12 illumination device
13 light beam
14 finger housing
15 light-emitting device
16 electrical energy storage device
17 switch
18 electrical cable
19 second illumination device
20 second light beam
21 second finger pocket
22 full-fingered glove
23 strap
24 hand pocket
25 channel
26 light transmission device
27 hand housing
28 second electrical cable

### DETAILED DESCRIPTION OF THE INVENTION

The present invention overcomes the limitations of the prior art by placing the point of light emission of an illumination device in the area between two adjacent fingers such that the point of light emission is in whole or in part between the fingers when the fingers are extended and positioned alongside each other. A number of embodiments of the present invention can serve to hold the point of light emission between the fingers.

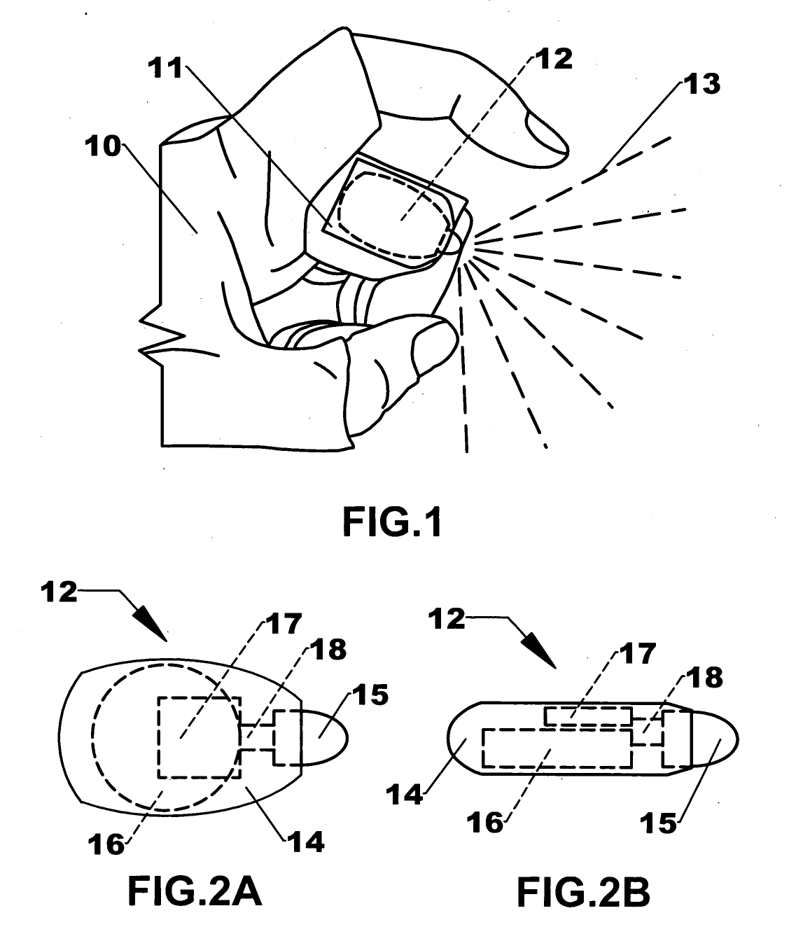

FIGS. 1, 3, 4, and 5 illustrate a preferred embodiment of the present invention. The hand-mounted illumination device comprises an illumination device 12 and a partial fingered glove 10 with illumination device 12 inserted into a finger pocket 11 located on the side of the second or middle finger of partial fingered glove 10, such that illumination device 12 projects light between the fingers, under the fingers and hand, around the fingertips, and distally of the hand. Partial fingered glove 10 and finger pocket 11 may be fabricated from a variety of flexible materials including but not limited to textiles, plastics, and rubbers, individually or in combination.

FIGS. 2A and 2B further illustrate illumination device 12, which comprises a finger housing 14, an electrical energy storage device 16, a switch 17, a light-emitting device 15, and an electrical cable 18 to interconnect the electrical components of illumination device 12. Illumination device 12 is of a size and shape predetermined to fit comfortably between the fingers. Finger housing 14 may be fabricated from plastic, metal, or other materials, either as a separate piece into which are inserted electrical energy storage device 16, switch 17, light-emitting device 15, and electrical cable 18, or finger housing 14 may be formed by encapsulating the electrical components in non-conductive, injection-molded material. Electrical energy storage device 16 may be any compact source of electrical energy such as a conventional battery or a fuel cell. Switch 17 may be a momentary device that requires the constant application of pressure for activation or it may be switched on or off by a single application of pressure. Light-emitting device 15 as illustrated is a light-emitting diode, but other means of light generation may be used such as incandescent or halogen bulbs or other electroluminescent devices. FIGS. 2A and 2B are intended to show a general representation of a miniature light suitable for use in the present invention and are not intended to limit the scope of the claims. Illumination device 12 may vary in shape, size, and materials, and the light produced by illumination device 12 may vary with regard to color, intensity, and focus.

In FIGS. 1, 3, 4, and 5, finger pocket 11 is attached to the side panel of the second finger of partial fingered glove 10 adjacent to the first or index finger such that finger pocket 11 is outside the surface of partial fingered glove 10. Finger pocket 11 may be fabricated from the same material as partial fingered glove 10 to reduce the visual impact and cost of fabrication of finger pocket 11, or finger pocket 11 may be made from a different material and attached to partial fingered glove 10 with adhesive, stitching, hook and loop fasteners, or other fastening methods. As illustrated in FIGS. 1, 3, and 4, finger pocket 11 is open at both its distal and proximate ends, and the distal end is narrower than the proximal end. The opening in the distal end of finger pocket 11 is of a size and shape sufficient to allow the light-emitting end of illumination device 12 to protrude from finger pocket 11, thereby permitting light-emitting device 15 to project a light beam 13 between, under, in front of the fingers, and preventing insertion or removal of illumination device 12 from the distal end of finger pocket 11. The opening in the proximal end of finger pocket 11 is of a size and shape sufficient to allow illumination device 12 to be inserted into or removed from finger pocket 11. Finger pocket 11 is positioned on partial fingered glove 10 such that the opening in the proximal end of finger pocket 11 is obstructed by the web of skin between the first and second fingers when the hand is inserted into partial fingered glove 10, thus preventing removal or insertion of illumination device 12 while partial fingered glove 10 is worn on a hand.

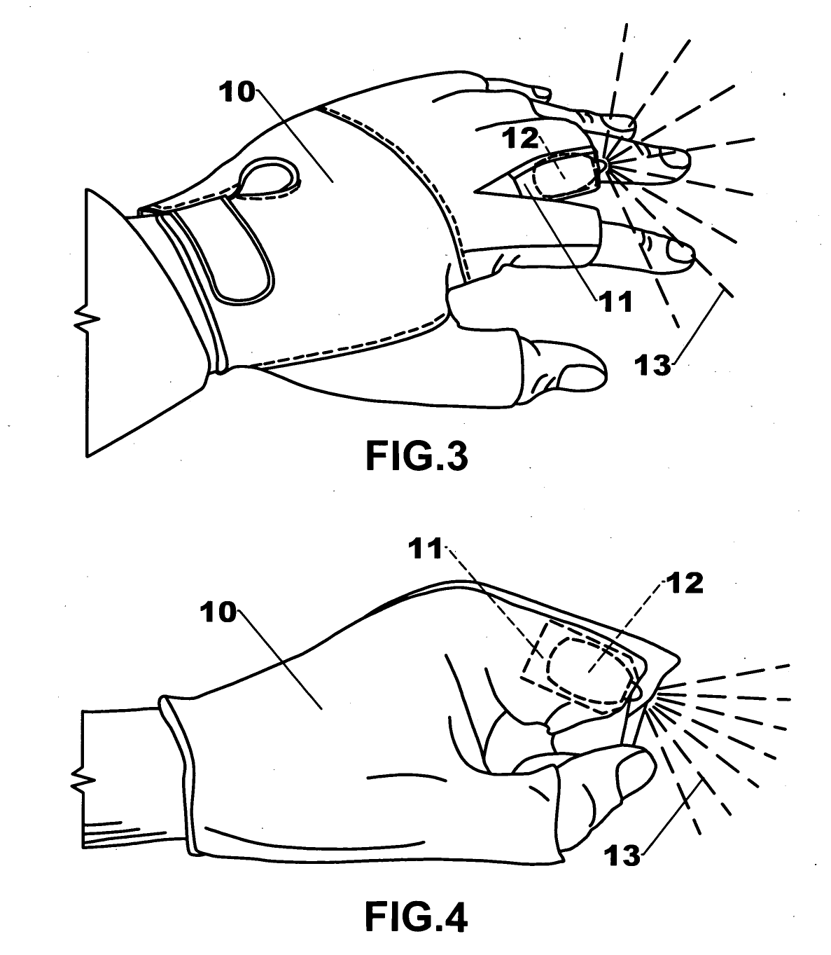

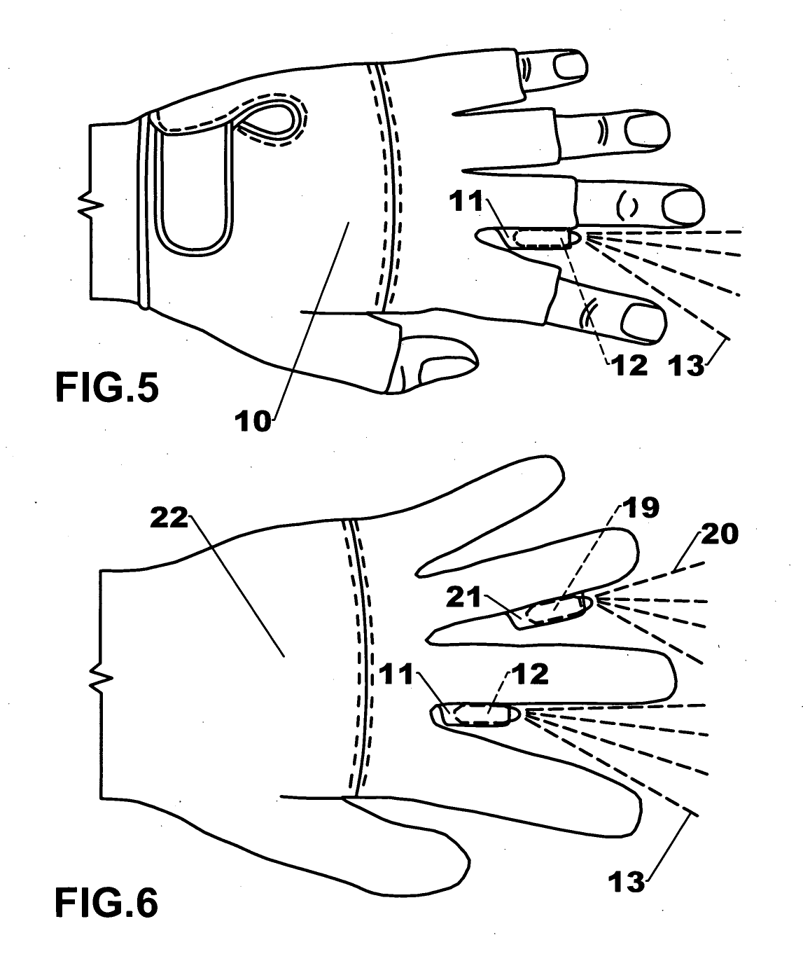

As illustrated in FIG. 1, the preferred embodiment of the hand-mounted illumination device is operated by raising the first finger away from the second finger, thereby permitting access to illumination device 12 by the thumb of the same hand. The thumb is used to press illumination device 12 against the second finger such that this pressure activates switch 17, thereby allowing one-handed operation of the hand-mounted illumination device. Illumination device 12 is removed or installed from finger pocket 11 by removing partial fingered glove 10 from the hand and spreading apart its first and second fingers, thereby accessing the proximal end of finger pocket 11 such that illumination device 12 may be removed from or installed into finger pocket 11. When used, the hand-mounted illumination device is merely aimed as needed by movement of the finger, hand, and arm, and switch 17 is pressed to activate illumination device 12. Light beam 13 illuminates the area between the fingers, under the hand, around the fingertips, and distally of the hand. When using the hand-mounted illumination device, as illustrated in FIGS. 3 and 5, the fingers may be straight, or as illustrated in FIG. 4, the fingers may be flexed into a gripping position. Thus, the hand-mounted illumination device may be used when the hand is gripping an object or when the hand is empty. As illustrated in FIG. 4, when the hand is in a gripping position, illumination device 12, with the exception of a portion of light-emitting device 15, is enclosed between the first and second fingers, thereby substantially reducing the possibility of snagging illumination device 12 on foreign objects, protecting illumination device 12 from damage, and substantially hiding illumination device 12 from view.

There are various possible alternatives to the preferred embodiment with regard to the size, shape, number, and location of the components of the hand-mounted. illumination device.

In FIG. 6, illumination device 12 is mounted on the second finger and a second illumination device 19 emitting a second light beam 20 is mounted in a second finger pocket 21 on the third finger of a full-fingered glove 22, such as a ski glove or work glove. This figure illustrates that more than one illumination device may be attached to different fingers of the same glove at various locations on the fingers, thereby illuminating a greater portion of the work area, eliminating shadows, and providing different colors, intensities, and foci of light. FIG. 6 also illustrates that the glove fingers may be full-length. This embodiment operates in substantially the same manner as the preferred embodiment.

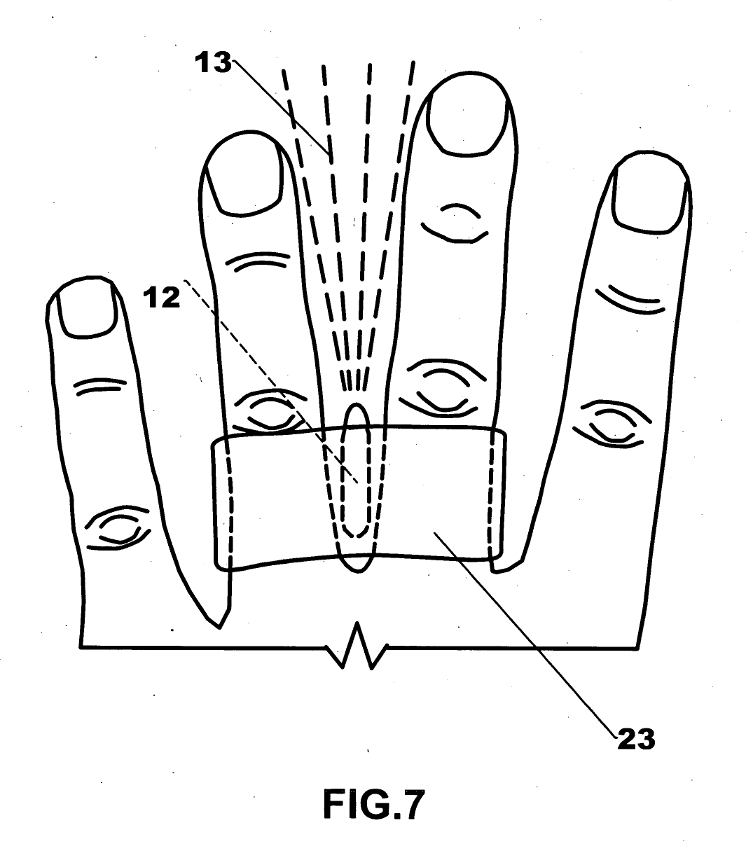

In FIG. 7, a band or strap 23 is used to hold illumination device 12 between two fingers. Strap 23 encircles both the second and third fingers and attaches illumination device 12 to the hand such that the point of light emission is between the fingers. Strap 23 may be fabricated from self-fitting elastic or other flexible materials that provide a comfortable and secure fit. This embodiment operates by applying pressure to the top and bottom of illumination device 12 with the thumb and first finger of the opposite hand such that switch 17 is activated. The advantage of this embodiment is simplicity of construction, lightweight, and the ability to attach the device to a bare hand or around the outside of an unrelated glove.

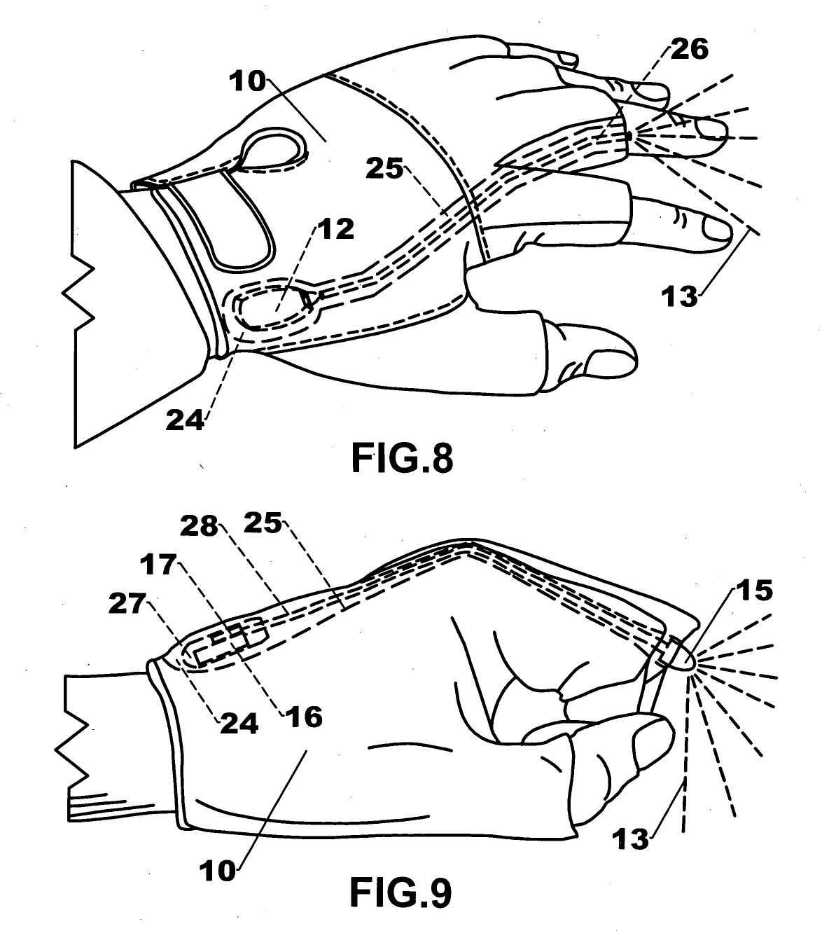

In FIG. 8, illumination device 12 is mounted in a hand pocket 24 attached to the back of partial fingered glove 10. A light transmission device 26, such as a fiber optic cable or plastic tube, transmits light from illumination device 12 through a channel 25 attached to partial fingered glove 10. Channel 25 runs from hand pocket 24 along the back of the hand, between the knuckles of the hand, along the side of the second finger to an exit from channel 25 at the distal end of the second finger of partial fingered glove 10. Light transmission device 26 exits channel 25 at the distal end of channel 25. Channel 25 may run on either side of the second or third finger or on the inside of the first or fourth finger. Routing channel 25 and light transmission device 26 between the knuckles and along the side of the finger allows light transmission device 26 to bend freely with the finger and reduces interference with finger motion. Hand pocket 24 may have an opening configured to allow removal or insertion of illumination device 12 and light transmission device 26. Light transmission device 26 may be either permanently fastened with adhesive or other methods to the distal end of channel 25, allowed to move into and out of the distal end of channel 25, or be held in place temporarily in the distal end of channel 25 by fittings designed for this purpose. This embodiment is operated by pressing switch 17 in illumination device 12 with a digit of the opposite hand. The advantages of this embodiment are first that electrical energy storage device 16 may be larger than in the preferred alternative, which provides increased illumination power and operation time, and second that no electrical components are located at the point of light emission.

In FIG. 9, electrical energy storage device 16 and switch 17 are disposed in a hand housing 27, and this assembly is inserted into hand pocket 24 attached to the back of partial fingered glove 10, and a second electrical cable 28 conducts electrical energy through channel 25 in partial fingered glove 10 to light-emitting device 15. Channel 25 runs from hand pocket 24 along the back of the hand, between the knuckles of the hand, along the side of the second finger to an exit from channel 25 at the distal end of the second finger of partial fingered glove 10. Second electrical cable 28 terminates at light-emitting device 15 that is disposed in the distal end of channel 25. Channel 25 may run on either side of the second or third finger or on the inside of the first or fourth finger. Routing channel 25 and second electrical cable 28 between the knuckles and along the side of a finger allows second electrical cable 28 to bend freely with the finger and reduces interference with finger motion. Hand pocket 24 may have an opening configured to allow removal or insertion of illumination device 12. Light-emitting device 15 may be either permanently fastened with adhesive or other methods to the distal end of channel 25, allowed to move into and out of the distal end of channel 25, or be held in place temporarily in the distal end of channel 25 by fittings designed for this purpose. This embodiment is operated by pressing switch 17 in illumination device 12 with a digit of the opposite hand. The advantage of this embodiment is that electrical energy storage device 16 may be larger than in the preferred alternative, which provides increased illumination power and operation time.

Thus, the reader will see that my hand-mounted illumination device is lightweight, securely attached, durable, not encumbering, inconspicuous, and easy to operate. Since the point of light emission in the present invention is not above the finger, the present invention lights objects between the fingers, under the hand and fingers, around the fingertips and distally of the hand, even when the fingers are flexed. Although such placement creates shadows laterally on the opposite sides of the fingers from the point of light emission, these shadows do not significantly impact the utility of the light and can be reduced by manipulation of the hand and fingers or by placing additional illumination devices between other fingers of the same hand. In addition, the present invention leaves the fingertip area unencumbered, does not restrict finger or hand motion, results in the point of light emission and adjacent illumination device components being protected by the fingers when the hand is grasping or made into a fist, presents a reduced risk of snagging foreign objects, may be configured for low visual impact, and does not limit the ability of the illumination device to project light to distant objects.

While the above description contains many specificities, these should not be construed as limitations on the scope of my hand-mounted illumination device. Many other variations are possible including using straps to attach the battery and switch to the back of the hand; placement of the battery or switch elsewhere on the body or in the clothing of the operator; placement of a battery on the back of the hand and a switch and light-emitting device on the side of a finger; using a fiber optic cable to transmit light or an electrically conductive wire to transmit electrical energy to the side of a finger from a remote source not connected to the hand; attaching an illumination device to the side of the finger of a glove with adhesive, straps, or hook and loop fasteners; shielding a part of the point of light emission of a light-emitting device to limit the dispersion of the light beam emitted; or integrating electronic circuitry that causes the illumination device to flash, automatically turn off, or provide different intensities of light.

While a number of embodiments of the hand-mounted illumination device have been described in detail, it should be apparent that modifications and variations to these embodiments are possible, all of which fall within the true spirit and scope of my invention. With respect to the above description then, it is to be realized that the optimum dimensional relationship for the parts of my invention, to include variations in size, materials, shape, form, function, and manner of operation, assembly and use, are deemed readily apparent and obvious to one skilled in the art, and all equivalent relationships to those illustrated in the drawings and described in the specification are intended to be encompassed by my invention.

Therefore, the foregoing is considered as illustrative only of the principles of my hand-mounted illumination device. Further, since numerous modifications and changes will readily occur to those skilled in the art, it is not desired to limit my invention to the exact construction and operation shown and described, and accordingly, all suitable modifications and equivalents may be resorted to, falling within the scope of my invention.

I claim:

1. A hand-mounted illumination device comprising:
a. an illumination means comprising an electrical energy storage means, a switch means, a light-emitting means, and an electrical energy transmission means, wherein said illumination means projects a beam of light from said light-emitting means, and
b. a support means adapted to fasten said light-emitting means to a hand,
wherein said support means attaches said light-emitting means to the hand such that the point of light emission of said light-emitting means is located on the side of a finger adjacent to an adjacent finger of the hand and the point of light emission of said light-emitting means is disposed between the finger and the adjacent finger when the fingers are extended and positioned alongside each other.

2. The hand-mounted illumination device of claim 1 wherein said support means is a glove having a plurality of fingers that cover at least a portion of at least one finger, and said light-emitting means is attached to a glove finger.

3. The hand-mounted illumination device of claim 2 further including a finger housing, wherein said electrical energy storage means, said switch means, said light-emitting means, and said electrical energy transmission means are disposed in said finger housing and said finger housing is attached to said glove finger.

4. The hand-mounted illumination device of claim 3 further including a finger pocket disposed in said glove finger, wherein a light beam can pass through the distal end of said finger pocket, said finger housing does not pass through the distal end of said finger pocket, and the proximal end of said finger pocket is of sufficient size so that said finger housing may be inserted into and removed from said finger pocket, such that said finger housing may be attached and detached from said glove finger.

5. The hand-mounted illumination device of claim 2 further including a hand housing, wherein said electrical energy storage means and said switch means are disposed in said hand housing, said hand housing is attached to the back of said glove, said light-emitting means is attached to said glove finger, and said electrical energy transmission means electrically connects said electrical energy storage means, said switch means, and said light-emitting means.

6. The hand-mounted illumination device in claim 5 further including a hand pocket and a channel, wherein said hand pocket is attached to the back of said glove, said hand housing is placed inside said hand pocket, said channel communicates between said hand pocket and said glove finger, said light-emitting means is disposed in the distal end of said channel, said electrical energy transmission means passes through said channel to said light-emitting means thereby electrically connecting said energy storage means, said switch means, and said light-emitting means, and said hand pocket comprises a means to open and close said hand pocket allowing insertion and removal of said illumination means.

7. The hand-mounted illumination device of claim 1 further including a finger housing, wherein said electrical energy storage means, said switch means, said light-emitting means, and said electrical energy transmission means are disposed in said finger housing, said support means is a strap attachment means, and said strap attachment means attaches said finger housing to at least one finger.

8. A hand-mounted illumination device comprising:
a. an illumination means comprising an electrical energy storage means, a switch means, a light-emitting means, a light transmission means, and an electrical energy transmission means, wherein said illumination means projects a beam of light from said light-emitting means through said light transmission means, and
b. a support means adapted to fasten said light transmission means to a hand,
wherein said support means attaches said light transmission means to the hand such that the distal end of said light transmission means is located on the side of a finger adjacent to an adjacent finger of the hand and the distal end of said light transmission means is disposed between the finger and the adjacent finger when the fingers are extended and positioned alongside each other.

9. The hand-mounted illumination device of claim 8 wherein said support means is a glove having a plurality of fingers that cover at least a portion of at least one finger, and the distal end of said light transmission means is attached to a glove finger.

10. The hand-mounted illumination device of claim 9 further including a hand housing, wherein said electrical energy storage means, said switch means, said light-emitting means, and said electrical energy transmission means are disposed in said hand housing, said hand housing is attached to the back of said glove, and said light transmission means conducts light from said light-emitting means to the distal end of said light transmission means.

11. The hand-mounted illumination device in claim 10 further including a hand pocket and a channel, wherein said hand pocket is attached to the back of said glove, said hand housing is disposed inside said hand pocket, said channel communicates between said hand pocket and said glove finger, said light transmission means passes through said channel to said glove finger, and said hand pocket comprises a means to open and close said hand pocket allowing insertion and removal of said illumination means.

12. A hand-mounted illumination device comprising:
a. an illumination device comprising a battery, a switch, a light-emitting diode, and an electrical energy transmission means, wherein said illumination device projects a beam of light from said light-emitting diode, and
b. a support means adapted to fasten said light-emitting diode to a hand,
wherein said support means attaches said illumination device to the hand such that the point of light emission of said illumination device is located on the side of a finger adjacent to an adjacent finger of the hand and the point of light emission of said illumination device is disposed between the finger and the adjacent finger when the fingers are extended and positioned alongside each other.

13. The hand-mounted illumination device of claim 12 wherein said support means is a glove having a plurality of fingers that cover at least a portion of at least one finger, and said light-emitting diode is attached to a glove finger.

14. The hand-mounted illumination device of claim 13 further including a finger housing and a finger pocket constructed in said glove finger, wherein said battery, said switch, said light-emitting diode, and said electrical energy transmission means are disposed in said finger housing, a light beam can pass through the distal end of said finger pocket, said finger housing does not pass through the distal end of said finger pocket, and said finger housing may be inserted into and taken out of the proximal end of said finger pocket, such that said finger housing may be attached and detached from said glove finger.

15. The hand-mounted illumination device of claim 13 further including a hand housing, a hand pocket and a channel, wherein said battery and said switch are enclosed in said hand housing, said hand pocket is attached to the back of said glove, said hand housing is placed inside said hand pocket, said channel communicates between said hand pocket and said glove finger, said light-emitting diode is disposed in the distal end of said channel, said electrical energy transmission means passes through said channel to said light-emitting diode thereby electrically connecting said battery, said switch, and said light-emitting means, and said hand pocket comprises a means to open and close said hand pocket allowing insertion and removal of said illumination device.

16. The hand-mounted illumination device of claim 12 further including a finger housing, wherein said battery, said switch, said light-emitting diode, and said electrical energy transmission means are disposed in said finger housing, said support means comprises a strap, and said strap attaches said finger housing to at least one finger.

17. The hand-mounted illumination device of claim 12 further including a fiber optic cable wherein said fiber optic cable is attached to said light-emitting diode such that said fiber optic cable transmits light from said light-emitting diode to the distal end of said fiber optic cable, and the distal end of said fiber optic cable is attached to the finger.

18. The hand-mounted illumination device of claim 17 wherein said support means is a glove having a plurality of fingers that cover at least a portion of at least one finger, and the distal end of said fiber optic cable is attached to a glove finger.

19. The hand-mounted illumination device of claim 18 further including a hand housing, wherein said battery, said switch, said light-emitting diode, and said electrical energy transmission means are disposed in said hand housing, said hand housing is attached to the back of said glove, and said fiber optic cable conducts light from said light-emitting diode to the distal end of said fiber optic cable.

20. The hand-mounted illumination device in claim 19 further including a hand pocket and a channel, wherein said hand pocket is attached to the back of said glove, said hand housing is placed inside said hand pocket, said channel communicates between said hand pocket and said glove finger, said fiber optic cable passes through said channel to said glove finger, and said hand pocket comprises a means to open and close said hand pocket allowing insertion and removal of said illumination device and said fiber optic cable.
